(19) United States
(12) Patent Application Publication
(10) Pub. No.: US 2026/0233466 A1
(43) Pub. Date: Aug. 13, 2026

(54) A METHOD AND SYSTEM FOR COMPARING MULTIPLE POLYMERIC MATERIALS FOR 3D PRINTING

(71) Applicant: TECTONIC-3D SWIP B.V., Eindhoven (NL)

(72) Inventor: Patrick Gerardus DUIS, Bergeijk (NL)

(21) Appl. No.: 19/470,910

(22) PCT Filed: Apr. 30, 2024
(86) PCT No.: PCT/NL2024/050223

§ 371 Date: Sep. 30, 2025

(30) Foreign Application Priority Data
May 1, 2023 (NL) 2034739

(51) Int. Cl. B29C 64/386; B33Y 40/20; B33Y 50/00; G01N 3/00

(52) U.S. Cl. CPC B29C 64/386; B33Y 40/20; B33Y 50/00; G01N 3/00; B29C 2793/0009; B29C 2793/009

(57) ABSTRACT

A method for comparing mechanical properties of multiple distinct polymeric materials suitable for 3D printing, includes a) using a first polymeric material of a group to form an object having a 2D area of macroscopic size, using a 3D printing process, b) printing the 2D area free standing in the air by layering horizontal layers on top of each other in a vertical direction c) thereafter cutting a test item out of the 2D area and establishing at least one mechanical property thereof d) repeating the above steps for each polymeric material of the group to form a set of multiple distinct objects, each corresponding to one distinct polymeric material. wherein each 2D area of each object is printed using the same printing process and in an equal period of time and having the same form, and e) compiling a list with each mechanical property of each distinct polymeric material.

### GENERAL FIELD OF THE INVENTION

The invention in general pertains to the art of 3D printing, also known as additive manufacturing, and in particular to the technology called fused deposition technology (FDM). The latter can be accomplished for example by drop-on-demand or continuous jet printing of polymeric materials, or so called fused filament fabrication (FFF) wherein an extruded line of polymer material (instead of individual droplets) is used to build up an object. Typical materials used in such 3D printing are polymeric materials. Choosing the right polymeric material that results in an object with desired properties, in particular and basically meeting at least a predetermined minimum mechanical strength is key in the design of an adequate 3D printing process. The present invention in particular enables a process of determining an adequate polymeric material for a particular 3D printing process.

### BACKGROUND OF THE INVENTION

3D printing can create physical objects from a geometrical representation by successive addition of material. The 3D printing process was first commercialised in the year 1980 by Charles Hull but has experienced a phenomenal expansion in recent years.

Currently, 3D printing is for example used for producing artificial heart pumps, jewellery, producing cornea, parts for rocket engines, buildings and other products related for example to the aviation industry as well as the food industry. 3D printing technology has originated from the layer-by-layer fabrication technology of three-dimensional structures directly from computer-aided design (CAD) drawings. 3D printing technology is a truly innovative and has emerged as a versatile technology stage. It opens new opportunities and gives hope to many possibilities for companies looking to improve manufacturing efficiency.

Conventional polymeric (e.g. thermoplastic and thermoset materials with or without any fillers) materials, ceramics, graphene-based materials, and metals are the materials that can be printed now by using 3D printing technology. 3D printing technology has the potential to revolutionise industries and change production methods. The adoption of 3D printing technology will increase the production speed while reducing costs. At the same time, the demand of the consumer will have more influence over production. Consumers have greater input in the final product and can request to have it produced to fit their specifications. At the meantime, the facilities of 3D printing technology will be located closer to the consumer, allowing for a more flexible and responsive manufacturing process, as well as greater quality control. Furthermore, when using 3D printing technology, the need for global transportation is significantly decreased. This is because, when manufacturing sites located nearer to the end destination, all distribution could be done with fleet tracking technology that saves energy and time. Lastly, the adoption of 3D printing technology can change the logistics of any company. Nowadays, 3D printing is widely used in the world. 3D printing technology increasingly used for the mass customization, production of any types of open-source designs in the field of agriculture, in healthcare, automotive industry, and aerospace industries. To sum up, 3D printing technology has emerged during recent years as a flexible and powerful technique in the advanced manufacturing industry.

Varieties of 3D printing technologies have been developed, fused deposition technology being one of them. This technology uses polymeric materials, in particular thermoplastic materials, for manufacturing an object by depositing layers of liquid material (meaning at least being fusible when deposited) on top of each other, typically in the form of individual droplets or filaments (bot referred to as “beads” in the art of 3D printing) and therewith form the desired object. By using fused deposition modelling, a 3D object can be printed through the deposition of successive layers of contiguous distinct droplets or extruded thermoplastic filaments. Typical polymers used for the polymeric materials for use in 3D printing technology are polylactic acid (PLA), acrylonitrile butadiene styrene (ABS), PETG, ASA, Polyamide 6, PA6.66, PA66.6, PA11 and PA12 polypropylene (PP) or polyethylene (PE). Lately, thermoplastics filaments with higher melting temperatures such as polyether ether ketone (PEEK) (peak family, PEEK, PEAK, PEKK and PEK), Poly ether imide (PEI), Polyimide (PI), PPS, PESU, PES and polymethyl methacrylate (PMMA) are used as materials for 3D printing technology.

The properties of the ultimate object inherently depend to a substantial part on the properties of the polymeric material. Although properties of polymeric materials, in particular mechanical properties such as tensile properties are commonly known, in practice finding a polymeric material suitable for printing a particular object is often a matter of trial-and-error.

### OBJECT OF THE INVENTION

It is an object of the invention to simplify the process of determining what polymeric material is suitable for use in a fused deposition 3D printing technology, in particular to arrive at an object that at least meets predetermined mechanical properties.

### SUMMARY OF THE INVENTION

In order to meet the object of the invention, a method for comparing mechanical properties of multiple distinct polymeric materials suitable for 3D printing has been devised, the method comprises the steps of a) using a first polymeric material out of the group of multiple distinct polymeric materials to form an object using a 3D printing process, the object comprising a 2D area of macroscopic size, b) printing the 2D area by layering the first polymeric material in a horizontal direction (X/Y-direction), preferably using a support for supporting the first layer of deposited material, a next layer being printed on top of a previous layer, therewith extending the object in the vertical direction (Z-direction) while being printed, wherein the 2D area is free standing in the air, c) after completion of the object, cutting a test item out of the 2D area, the test item being subjected to process for establishing at least one mechanical property of this item, and d) repeating the steps a, b and c for each of the other polymeric materials out of the group of multiple distinct polymeric materials thereby forming a set of multiple distinct objects each of which objects corresponds to one of the said multiple distinct polymeric materials, wherein each of the 2D areas of each of the objects is printed using the same printing process and each of the 2D areas is printed in an equal period of time and having the same form; and lastly compiling a list with each of the at least one mechanical property of each of the multiple distinct polymeric materials.

The invention was based on a couple of recognitions. The first one being that a mechanical property of a bulk material is hardly representative for a mechanical property of an object made by fused deposition of this material. For the latter, the interaction between the various fused layers has a substantial influence on the properties of the resulting object. Secondly, the inventors recognised that mechanical properties as listed in product sheets of suppliers are in most cases measured in unknown devices or according to unknown methods, and even if known, one method cannot be compared with the other. Since each supplier may use its own device or method, bulk properties can often not be compared in a sensible way. This could be solved by printing a test item such as a tension bar, and using that item for establishing mechanical properties. However, another critical recognition was that in 3D printing, the process of obtaining an object is often dominated by aesthetics: the manufacturer desires to obtain objects without artefacts, in particular with smooth and clear outer circumference lines. For this often a printing method is chosen that is directed to obtaining a nice-looking object, instead of aiming at an object that is ideally suitable for determining its mechanical properties. The artifacts of printing direct parts can heavily influence reliability of the tensile tests or other tests performed. For example, if a supplier prints tension bars for obtaining mechanical properties, the properties may and often will vary considerably depending on the desired aesthetics of the object. Lastly, it was recognised that the mechanical properties of printed items may to a substantial part vary depending on what support the item is printed. Such a support is often referred to as a “print bed” in the art and may for example consist of a heated platform of glass, carbon or the like and optionally provided with a polymer sheeting and a topcoat of an adhesion promotor. If a heated print bed is used, this will dominate the fusion process of at least a part of the produced part. This typically has a substantial influence on the ultimate properties of the object that is printed.

All of the above let to the insight that a method that leads to a situation wherein established properties, in particular a mechanical property such as tensile properties such as tensile strength, modulus and elongation, can be objectively compared must be restricted to the technical features of the invention:
a) using a first polymeric material to form an object using a 3D printing process, the object comprising a 2D area of macroscopic size,
b) printing the 2D area by layering the first polymeric material in a horizontal direction (X/Y-direction), a next layer being printed on top of a previous layer, therewith extending the object in the vertical direction (Z-direction) while being printed, wherein the 2D area is free standing in the air (i.e. any gaseous environment), and
c) after completion of the object, cutting a test item out of the 2D area (for example by milling, punching, water jetting or laser cutting etc.), the test item being subjected to process for establishing at least one mechanical property of this item;

Importantly, the object comprises a relatively large 2D area (a plate like area) of some thickness, minimally the thickness of one line of beads (i.e. the droplets or filaments), and maximally a few up to for example 10 of these beads, out of which a test item can be cut. The test item is thus indirectly printed as part of a larger 2D area, and thus, there need to be no print artefacts in this item which typically occur adjacent the circumference of a printed object. Also, the fact that the item is cut out of a flat, plate like area (the 2D area) is important, since this makes testing the ultimate item far more easy and thus reliable and consistent when printing and testing multiple items in a row. It is also important to print the 2D area as a free-standing object, which avoids interference in the properties of any print bed or adhesion promoter. This is accomplished by building up the area in Z-direction (i.e. the vertical direction) by layering the material in X/Y-direction. This way, the 2D surface while being printed extends in the Z-direction, the two opposing flat surfaces of the 2D area thus not being in contact with any supporting material (which could interfere with the properties of the 2D area while being formed by fusion of the printed material droplets, bulbs or lines). In other words, the thickness of the 2D area extends in the X/Y (horizontal) direction and the length/width, defining the surface itself, extends in the Z (vertical) direction, surrounded by air, the surfaces not being in contact with any solid support material while being printed. The object is free-standing in air, which “air” may be part a controlled area such as a closed chamber for controlling the temperature and composition of the air (e.g, close to the Tg of the polymer material and free of non-inert gases such as oxygen, e.g by using pure nitrogen). By incorporating all of these technical features, test items can be provided which are not (or at least to a minimal extent) prone to print artefacts typical for 3D printing, and are a realistic representative of walls/parts of an actual object to be printed in the future.

By making sure the process is repeated exactly the same way for any polymeric material, thus repeating the steps a, b and c for each of the other polymeric materials, a set of multiple distinct objects is formed, wherein each of the 2D areas of each of the objects is printed using the same printing process parameters such as print speed, layer height and bead width, and printed in an equal period of time, as well as having the same form, such that each test item is technically equivalent to all the other ones. This way, if mechanical (or other) properties are measured for each of the items, the results are a true representative for properties when used for printed real objects and for the differences between the various polymeric materials. This means that the mechanical properties of test items cut out of each of these objects can be objectively compared: the printing process was the same and there are no artefacts created due to a limitation of desiring a smooth circumference of the object. The only relevant variable that needs to be adjusted when printing the various objects is the temperature of the printing head, since each material will have its own melting temperature and glass transition temperature. However, this same difference in temperature will also be applied during actual printing of an object, so this will not lead to any anomalies in the comparison of the various materials. On the contrary, the difference in temperature during printing of the test item (as part of the object) will be representative for the temperature during actual printing of any object later on. The print temperature and the speed may be varied when producing the set of objects with the aim to perform a process window study to mimic circumstances corresponding to the printing of large parts (using a lower printing speed) or small parts (using a high printing speed). This way the properties of the various materials across a wide processing window can be reliably established. Also, the effect of temperature can be studied with lower of hotter printing temperature, chamber temp etc).

It is noted that the invention is not restricted to establishing any particular mechanical property of the printed polymeric material. It may be the tensile strength, any modulus, a resistance to impact, etc. etc.). In addition to one or more mechanical properties, the method can be used for determining properties like flammability, GWIT (e.g. Glow wire ignition temperature), and electrical properties like CTI (comparison tracking index)etc. The tests methods for these properties are extremely sensitive for print defects and can lead to unrealistic behavior in the test when certain print defects are present.

The invention is also embodied in a system for determining whether a polymeric material is suitable for use in a particular 3D printing technology, the system comprising a central processing unit (CPU) operatively coupled to a memory which comprises the list with each of the at least one mechanical property of multiple distinct polymeric materials as provided by using a method according to the invention as explained here above, the CPU being programmed to determine based on input regarding at least the said 3D printing technology what polymeric material out of the list of multiple distinct polymeric materials is suitable for use in the 3D printing technology. This system allows for making proposals for the most suitable polymeric materials to be applied in a 3D printing process instead of a time-consuming trial and error process.

Preferably the CPU is operative coupled to a user interface that allows a human operator to provide data regarding at least the 3D printing technology to the CPU, and to allow the user to review the determination of the CPU regarding what polymeric material out of the list of multiple distinct polymeric materials is suitable for use in the said 3D printing technology.

### DEFINITIONS

A polymeric material is a material which comprises as a main component a polymer, thus at least over 50% w/w. The polymer content may be higher, for example 55, 60, 65, 70, 75, 80, 81, 82, 83, 84, 85, 86, 87, 88, 89, 90, 91, 92, 93, 94, 95, 96, 97, 98, 99 up to even 100% w/w. However, the material may comprise other compounds such as fillers, stabilisers, dispersant, flame retardation compounds, conductivity enhancers, pigments etc.

3D printing is a form of additive manufacturing wherein molten material is deposited on a support, layer by layer, to ultimately form an object of fused elements of this material. The elements may be deposited in the form of droplets, filaments, ribbons etc.

One 3D printing process being the same as another 3D printing process means that in essence the same printing technology is used (for example by using the same printer, or the same type of printer), producing elements for fusing (droplets, filaments, ribbons) at the same speed, with the same dimensions that are able to build the same object in the same period of time.

A 2D area of macroscopic size is an area that is plate-like, thus being in essence flat and having length and width dimensions (X/Y) that are substantially larger than the height dimensions (Z, the “thickness” of the plate like area), i.e. at least 10 times larger, preferably even 11, 12, 13, 14, 15, 16, 17, 18, 19, 20, 25, 30, 35, 40, 45, 50, 60, 70, 80, 90 or even 100 times or over larger than the height dimension, wherein the length and width dimensions are over 1 mm, preferably over 5, 10, 15, 20, 25, 30, 35, 40, 45, 50, 55, 60, 65, 70, 75, 80, 85, 90, 95, 100 or more mm.

Two 3D printed objects having the same form mean that their intended end form (i.e. shape, size and wall thickness) is in essence (on a macroscopic level) the same. Slight differences can come about from differences in materials leading e.g., to a different surface texture, a different edge form, different artefacts etc.

A water jet cutter, also known as a water jet or waterjet, is an industrial tool capable of cutting a wide variety of materials using an extremely high-pressure jet of water, or with a mixture of water and an abrasive substance if needed.

### FURTHER EMBODIMENTS OF THE INVENTION

In a first further embodiment of the method according to the invention, each of the objects as a whole in the set of multiple distinct objects have the same form and are printed in an equal period of time. So not only each of the 2D areas is printed with the same printing characteristics, but each of the whole objects, increasing the certainty that also each area is indeed printed the same way, i.e. with the same printing characteristics (such as speed).

In a second further embodiment of the method according to the invention, the test item is cut out of the 2D area using a water jet cutter. The inventors realised that when cutting a test item out of the 2D area of a 3D printed object, there is a risk that the item undergoes physical changes that involve a change in mechanical properties of the item, due to the process of cutting itself. Cutting namely often goes together with the production of heat, which means that part of the fused polymeric material can be remelted. This will lead to a change in properties of the item post printing and thus, means that the determination of the mechanical properties is not only determined by the polymeric material and the printing process, but also by the cutting process. This risk can be mitigated or even prevented by cutting the test item out of the 2D area using a water jet cutter, which leads to hardly any (if at all) heat transfer into the test item.

In yet a further embodiment of the method according to the invention, the test item is an elongated item, such as a tension bar. An elongated item is more convenient for performing a process for establishing mechanical or other properties. A tension bar is a common test item for such tests. Preferably two test items are cut out of the 2D area, one of these extending in X/Y-direction in the 2D area, the other extending in Z-direction in the 2D area. This way the properties can be established in the two main directions. This is important since 3D printing by a fused deposition technology inherently leads to non-uniform properties.

In again a further embodiment of the method according to the invention, the thickness of the 2D area is between 0.2 and 8 mm, preferably between 0.5 and 4 mm, such as 1, 1.5, 2, 2.5, and 3 mm. These thicknesses have been found ideal for use in common test methods for establishing one or more mechanical properties such as ASTM D638 or ISO 527 standards and certification standards like FAR 25.853, UL 94 blue card and EN45545-2

In still a further embodiment of the method according to the invention, the object is a plate standing upright. Such object has been found suitable for use in the present method, in particular for 2D areas that have a thickness of multiple beads (i.e., the droplets, filaments or ribbons) that are deposited side by side to form the plate. Preferably, the vertically extending lateral edges of the plate are curved. It was found that next to the advantage of having built-in lateral supports for the plate to stand upright, it has appeared that the curved edges prevent warpage of the intermediate 2D area, at least to a substantial level.

In yet again a further embodiment of the method according to the invention, the object is a polygon (in the X/Y plane, extending in the Z-direction; see FIG. 4). This embodiment is particularly suitable for so called single wall 2D areas, i.e. walls that have a thickness of only one deposited liquid unit. For most of such units, a plate standing upright would be too thin to be able and build a free-standing plate. By forming a polygon, the object has sufficient mechanical strength to be build up as a single wall object. Such walls are advantageous for testing the most rudimentary properties of fused deposited units, thus representing the most direct relationship between fusion strength and printing technology. By using single wall test items, polymeric materials can be tested and compared on the most fundamental level. Preferably, the object is chosen from the group consisting of trigon, tetragon, pentagon, hexagon, heptagon and octagon, most preferably a hexagon.

In still again a further embodiment of the method according to the invention, steps a) to e) are repeated for the said multiple distinct polymeric materials, thereby forming at least one second set of multiple distinct objects each of which objects corresponds to one of the said multiple distinct polymeric materials, wherein for printing the second set of objects a different printing speed is used than used for printing the objects of the first set. By making sets of test items printed at different speeds a broad range of mechanical properties can be tested, which makes the list more suitable for use in finding the most promising polymeric material for a broad range of 3D printers and applications.

In a further embodiment of the method according to the invention, the list is operatively coupled to a list of multiple distinct applications of 3D printed objects. This way, the list with mechanical properties is linked to various applications making it easier to find the right material for a particular application.

Correspondingly, in yet a further embodiment of the method according to the invention, the list is operatively coupled to a list of multiple distinct 3D printers.

The invention will now be further explained using the following particular examples.

### EXAMPLES

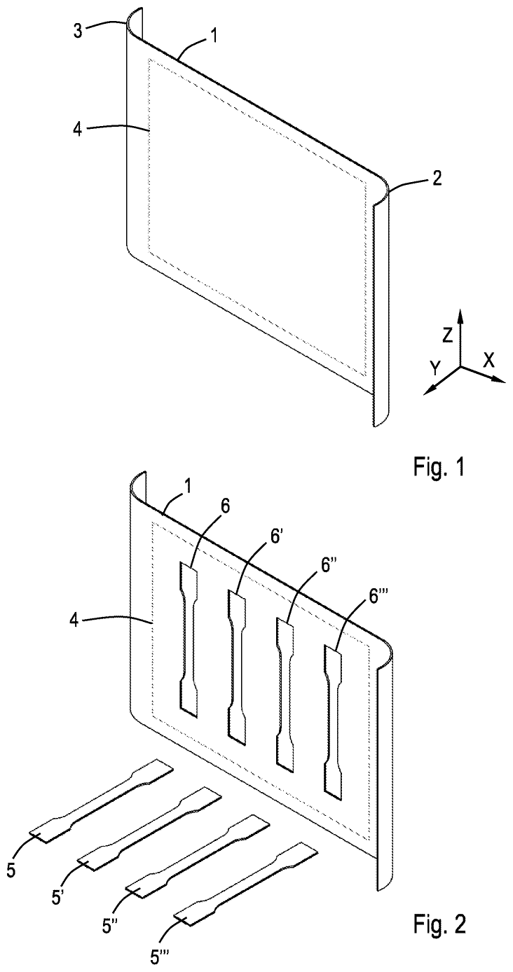

FIG. 1 is a schematic representation of an object printed for use in the present method.

FIG. 2 is the object of FIG. 1, with multiple test items cut out of its 2D area.

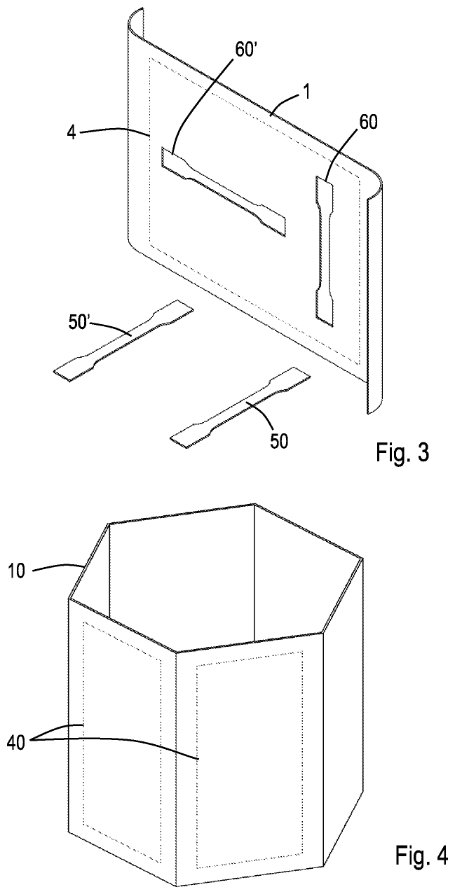

FIG. 3 is the object of FIG. 1, with two perpendicular test items cut out of its 2D area.

FIG. 4 is a single wall object in the form of a hexagon.

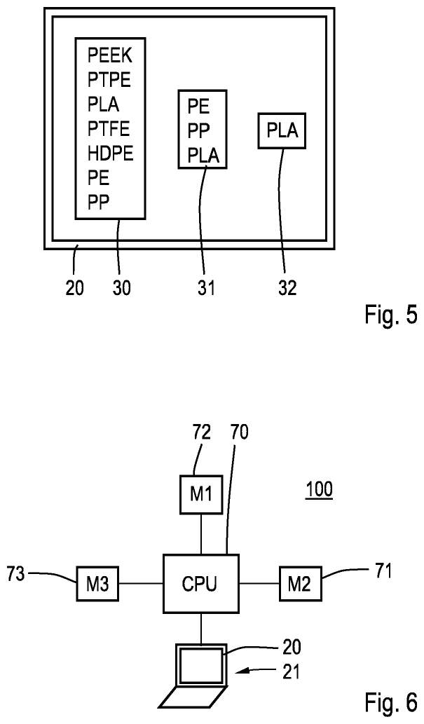

FIG. 5 is a display showing a list of tested polymeric materials.

FIG. 6 is a system for generating a proposal for a polymeric material.

Example 1 provides information about potential uses of the current invention.

### FIG. 1

FIG. 1 is a schematic representation of an object 1 printed for use in the present method. The object is a free-standing wall of a polymeric material (the type of material is not essential), printed with a Fused Filament Printer, wherein the wall has a thickness of 4 contiguous filaments being deposited next to each other, leading to a thickness of 2 mm. The wall stands on a horizontal support (not shown) while being printed and is built up by depositing filaments on top of each other in the Z direction. This way, the footprint of the wall does not change while the wall is being printed, but the length in which it extends in the Z-direction continuously grows while the printing process takes place. This way, both opposing surfaces of the wall are surrounded by air while being printed, the surfaces not being in contact with any solid support material during this process. This makes sure that the fusing process of the liquid material used for printing is not influenced by transport of heat from or to the support.

In this embodiment the wall has curved lateral edges 2 and 3 to make sure the wall is self-supporting (no additional structures are needed to prevent that the wall topples over) and to prevent warpage of the center section of the wall. 2D area 4 is part of this center section and has dimensions of 8 cm (width) by 8 cm (height), with a thickness of 2 mm as indicated here above. The object 1 is used for cutting test items out of the 2D area 4, as indicated in FIG. 2. This way five tension bars that fulfill ISO standard 1BA (75 mm long, 10 mm width) can be cut out of the area 4.

### FIG. 2

FIG. 2 is the object 1 of FIG. 1, with multiple test items cut out of its 2D area 4 using a common water cutter to prevent that the object is remelted adjacent the cutting area. As can be seen, multiple tension bars 5, 5′, 5″ and 5″′ are cut out of the 2D area 4. Leaving openings 6, 6′, 6″ and 6″′ respectively. The tension bars can be used in any system to establish mechanical properties of a (polymeric) material.

FIG. 3 is the object 1 of FIG. 1, with two perpendicular test items 50 and 50′ are cut out of its 2D area 4. Item 50 (leaving opening 60 in object 1) is cut out in the Z-direction and item 50′ (leaving opening 60′ in object 1) is cut out in the X-direction (called “on edge”). With this, two extreme mechanical property values can be established which can be used for computer aided engineering (CAE) tools and designing of parts.

### FIG. 4

FIG. 4 is a single wall object 10 in the form of a hexagon. Such an object is ideally suitable for testing the properties of single walls but may also be useful for thicker walls (although the printing time needed is probably relatively long when compared to for example printing a free-standing wall such as shown in FIG. 1). The single wall object provides the option of a test item to establish the real strength of a polymer in it most weak situation. A tensile bar (e.g. ISO 1B) will be cut out of one of the areas 40 and tested in Z-direction. This gives a very clean and practical value on the initial strength of a material. Test may be done for a single speed of for example 30 mm/s, but this speed may also be increased or decreased to mimic the printing of smaller or larger parts. In any case, using a single wall test item provides a very fast indication of how a polymeric material performs in actual fusion strength.

### FIG. 5

FIG. 5 is a display 20 (for example a display of a laptop computer) showing a list 30 of tested polymeric materials. This list is a complete list of materials tested for a mechanical property in a particular test. List 31 is a shortlist of polymeric materials that are found to be suitable for use in a particular application, based on the established property. List 32 is an even shorter list providing the best option for the polymeric material.

### FIG. 6

FIG. 6 is a system 100 for generating a proposal for a polymeric material. The system comprises a Central Processing Unit (CPU) 70, and connected with that several memories 71, 72, and 73 for storing data regarding properties of multiple polymeric materials (in memory 71), 3D printing applications (memory 72) and 3D printing technologies/printers (in memory 73). The data in the memories is inputted via user interface 21, in this a laptop computer. The CPU is programmed to determine based on input regarding at least a 3D printing technology and/or a 3D printing application what polymeric material out of the list of multiple distinct polymeric materials is suitable for use in the 3D printing method. This system allows for making proposals for the most suitable polymeric materials to be applied in a 3D printing process instead of a time-consuming trial and error process as commonly used in the art.

### Example 1

Example 1 provides information about using the current invention. By establishing mechanical properties of multiple polymeric materials, it is possible to objectively compare these materials that are tested in the same geometry and using the same printing conditions. The only potential variation is the temperature of the polymeric material at printing, and the inherent concomitant adaptation of the print chamber and its nozzle if needed, as commonly known in the art of printing polymeric materials. Also, by varying the print speed, the printing of parts with different size can be mimicked (a large part size can be mimicked using a low printing speed). Next to this, besides one mechanical property, polymeric materials can be tested for various properties needed for example for UL(flammibility), EN45545-2 (Railway) and FAR (Aerospace) standards. This can be done using the present method so that materials in application safety performance in different thicknesses and print directions can be compared objectively. The platform as a whole is tentatively called the “Tectonic-3D data platform for Additive manufacturing” (OBSON@ is the tradename). This platform can be used as an additive manufacturing accelerator and development partner to help companies looking for additive solutions to connect with the best material and hardware solutions in the marketplace and help qualify those innovative technologies with those customers.

The current state of the industry is dominated by either machine manufacturers or chemical companies that develop solutions based on their technology. At this stage of the maturity level of additive manufacturing application, development is a critical component to grow this industry. This knowledge is traditionally at chemical companies, but they struggle with the fragmentation and market size of AM. Also, an aging population of polymer chemists results in less knowledge transfer to AM. Next to this, the development of new materials staggers and limited solutions are being offered. The machine manufacturers are typically mechanical engineers and have limited knowledge in polymer science and materials.

As a result, there is a large gap in the market regarding developing applications with the right materials suitable for the application. As a result, many AM companies work with polymeric materials that are not ideally suitable for their desired application.

The current invention allows to bridge this gap between polymer suppliers and AM companies to allow a wider availability of polymer materials suitable for AM applications and printers. For application development in AM more design and polymer material knowledge is needed than currently available, since there are many material parameters that can affect the print quality and performance of the ultimate object to be manufactured. In comparison, for injection moulding there are many standardised ways to describe materials and using CAE software to predict performance. This is all established in various ISO, ASTM, FAR and EN standards. However, for AM there are no clear data sets and every polymer company has its own way and equipment to test properties and highlight only the best results, often obtained under circumstances that are hardly representative for real-world 3D printing. Indeed, one of the drawbacks of 3D printing is the non-uniform performance of various polymer materials. The weakest link is the fusion between printed layers of deposited units which can even be as lows as 25% of the original bulk material, typically in the Z-direction, called the Z-strength between layers. This requires advanced design skills to overcome these hurdles.

One of the aims of the current invention is to bridge this gap with a standard way of working and measuring polymeric materials and establishing links with 3D printing application knowledge and printing technology. For this, a so-called Customer Relation Management (CRM) system can be used where industry specific multidirectional links are added that pertain to the properties of the polymeric materials, printers, applications and standards. The data per polymeric material is obtained using a unified testing protocol. Preferably, use is made of a fixed machine/hot-end configuration for two sets of materials (standard and engineering materials). This results in a fixed configuration and also a way to be able and objectively compare properties of a variety of polymeric materials.

The data regarding the established mechanical properties is stored in a database and will be linked to CRM to make links to printing applications and application requirements that can be stored at the start of a project to identify the most suitable polymer material for a particular printing application. By measuring multiple materials, a system is built with many interlinked datasets, which system will become “smarter” over time when more data is stored. Optionally an AI (Artificial intelligence) system may be applied to the data to be able and predict the composition of new materials, machines or applications. The system may be opened to customers via user interfaces which guide them to the application development process in an automated way. The data regarding all polymeric materials are stored in the system, in conjunction with production and quality data with the aim that print quality can be controlled on a material level and the most suitable polymeric materials can be supplied to achieve the best quality for each particular 3D printing application.

What is claimed is:

1. A method for comparing mechanical properties of multiple distinct polymeric materials suitable for 3D printing, the method comprising the steps of:
a) using a first polymeric material out of a group of multiple distinct polymeric materials to form an object using a 3D printing process, the object comprising a 2D area of macroscopic size;
b) printing the 2D area by layering the first polymeric material in a horizontal direction (X/Y-direction), a next layer being printed on top of a previous layer, therewith extending the object in a vertical direction (Z-direction) while being printed, wherein the 2D area is free standing in the air;
c) after completion of the object, cutting a test item out of the 2D area, the test item being subjected to a process for establishing at least one mechanical property of this test item;
d) repeating the steps a, b and c for each of the other polymeric materials of the group of multiple distinct polymeric materials thereby forming a set of multiple distinct objects each of which objects corresponds to one of the said multiple distinct polymeric materials, wherein each of the 2D areas of each of the objects is printed using the same printing process and each of the 2D areas is printed in an equal period of time and having the same form; and
e) compiling a list with each of the at least one mechanical property of each of the multiple distinct polymeric materials.

2. A method according to claim 1, wherein each of the objects as a whole in the set of multiple distinct objects has the same form and is printed in an equal period of time.

3. A method according to claim 1, further comprising the step of cutting the test item out of the 2D area using a water jet cutter.

4. A method according to claim 1, wherein the test item is an elongated item.

5. A method according to claim 4, wherein said step of cutting includes the step of cutting two said test items out of the 2D area, one of these extending in an X/Y-direction in the 2D area, and the other extending in a Z-direction in the 2D area.

6. A method according to claim 1, wherein the thickness of the 2D area is one of:
between 0.2 and 8 mm, or
between 0.5 and 4 mm.

7. A method according to claim 1, wherein the object is a plate standing upright.

8. A method according to claim 7, wherein the plate has vertically extending lateral edges of the plate which are curved.

9. A method according to claim 1, wherein the object is a polygon.

10. A method according to claim 9, wherein the object is chosen from the group consisting of a trigon, tetragon, pentagon, hexagon, heptagon and octagon.

11. A method according to claim 1, further comprising repeating steps a) to e) are repeated for the said multiple distinct polymeric materials, thereby forming at least one second set of multiple distinct objects each of which objects corresponds to one of the said multiple distinct polymeric materials, wherein for printing the second set of objects a different printing speed is used than used for printing the objects of the first set.

12. A method according to claim 1, further comprising the step of operatively coupling the list to a list of multiple distinct applications of 3D printed objects.

13. A method according to claim 1, further comprising the step of operatively coupling the list to a list of multiple distinct 3D printers.

14. A system for determining whether a polymeric material is suitable for use in a particular 3D printing technology according to claim 1, the system comprising:
a central processing unit (CPU), and
a memory operatively coupled to the CPU, the memory including the list with each of the at least one mechanical property of multiple distinct polymeric materials as provided by the method according to claim 1,
wherein the CPU is programmed to determine based on input regarding at least the said 3D printing technology what polymeric material out of the list of multiple distinct polymeric materials is suitable for use in the 3D printing technology.

15. A system according to claim 14, wherein the CPU is operatively coupled to a user interface that allows a human operator to provide data regarding at least the 3D printing technology to the CPU, and to allow the user to review the determination of the CPU regarding what polymeric material out of the list of multiple distinct polymeric materials is suitable for use in the said 3D printing technology.

16. A method according to claim 4, wherein the elongated item is a tension bar.
